(19) United States
(12) Patent Application Publication
(10) Pub. No.: US 2012/0204093 A1
(43) Pub. Date: Aug. 9, 2012

(54) PROVIDING WEB-BASED CONTENT TO LOCAL DEVICE

(75) Inventors: Shyam S. Habarakada, Seattle, WA (US); Matthew Jason Pope, Seattle, WA (US); Joshua Charles Zana, Seattle, WA (US); Rahul Ravindran, Bellevue, WA (US); David Richard Reed, Seattle, WA (US)

(73) Assignee: Microsoft Corporation, Redmond, WA (US)

(21) Appl. No.: 13/022,794

(22) Filed: Feb. 8, 2011

(51) Int. Cl. G06F 17/00; G06F 3/01; G06F 15/16

(52) U.S. Cl. 715/234

(57) ABSTRACT

One or more techniques and/or systems are disclosed for sending web-based content to a local device (e.g., TV) using a personal device (e.g., smartphone). A user can open a web-based document that comprises desired web-based content on their personal device (e.g., smartphone). Upon opening the web-based document, a document element can be dynamically generated in the web-based document that comprises a source served by a remote pairing service. A user interface (UI) can be rendered on the personal device, such as “send content” button. When the user activates (e.g., clicks on) the UI, the web-based content can be provided to the local device (e.g., TV), by sending or pulling, where the local device can be paired with the personal device by the remote pairing service.

### BACKGROUND

There are a variety of ways for users to view web-based content, and a variety of devices that may be used to view said content. For example, a user may use a portable handheld computer to browse the Internet, utilizing a browser resident on the handheld computer. The user can navigate to a variety of pages which respectively may comprise viewable content, such as videos, images, audio, animations, rich multi-media graphical elements, and more. Further, a user may have access to a television or display device locally, such as at home, work or at another venue, where they can watch television programming, pre-recorded content, and/or play games using an attached gaming console. Additionally, some televisions and/or larger display devices may be able to access the Internet, such as using components resident in the television or using a connected web-enabled device (e.g., gaming console or computer).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

There is a growing selection of devices which can display media rich web content, such as Internet connected personal devices (e.g., smartphones, handheld computers, laptops) and/or web enabled televisions, for example. Often, users find web-based content on a personal device comprising a small display screen, and want to view that same content on a larger screen, such as their local television. For example, a user may be browsing photo albums on a web site, using a smartphone, and may wish to project this experience to a TV screen in their living room for sharing the photos with friends. Similarly, a video sharing website user may be watching a video on their phone and wish to transfer the video to the TV screen for a better content viewing experience.

Currently, there is not a standard way to project a variety of web-based content from a user's personal device to a user's local device, in a broad, web technology ready form. Current standards, such as the HTML specification (e.g. HTML5) and/or today's web extensibility platforms (e.g. rich multi-media extensibility frameworks) do not support a way for web content authors, providers, etc. to enable the sending of content, for example, to TVs and/or other larger screen displays from a personal device. Further, current techniques utilize proprietary protocols for sending content directly from a proprietary device to a television, and do not allow the viewing of content to be controlled by a developer, author, etc. of a website comprising the content, for example.

Accordingly, one or more techniques and/or systems are disclosed where a user may project a variety of web-based content, identified on their personal device, for viewing on their local device, such as a television or other large screen displays. For example, a simple and intuitive user gesture, may be used to send content to a television without a need for making a physical connection between the initiating device and the large screen display.

In one embodiment for sending web-based content to a local device using a personal device, a document element can be dynamically generated when a web-based document, that comprises desired web-based content, is opened on the personal device. The document element can comprise a source that is served by a remote pairing service. Further, a user interface (UI) can be rendered on the personal device. When the UI is activated the web-based content can be provided to the local device. Here, the local device can be paired with the personal device by the remote pairing service.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a diagram illustrating an example environment where one or more techniques described herein may be implemented.

FIG. 2 is a flow diagram of a exemplary method for sending web-based content to a local device using a personal device

FIG. 3 is a flow diagram illustrating an example embodiment where one or more portions of one or more techniques described herein may be implemented.

FIG. 4 is an example embodiment of a web-based document implementing one or more aspects described herein.

FIG. 5 a flow diagram illustrating an example embodiment where one or more portions of one or more techniques described herein may be implemented.

FIG. 6 is a component diagram of an exemplary system for sending web-based content to a local device using a personal device.

FIG. 7 is a component diagram illustrating one embodiment where one or more systems described herein can be implemented.

FIG. 8 is an illustration of an exemplary computer-readable medium comprising processor-executable instructions configured to embody one or more of the provisions set forth herein.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for viewing web-based content on a user's local device, such as a television or some other large screen display, where the web-based content has been selected by a user on a personal device, such as a smartphone or laptop computer. For example, a user may own and/or have access to one or more TVs in their home, work or other environment. Further, in this example, the user may be browsing the Internet and find content, such as a video or image(s), that they wish to view on one or their TVs. In one embodiment, the user may be able to use a simple and familiar gesture (e.g., clicking on an icon) to send the web-based content to a desired television (e.g., a device local to the user).

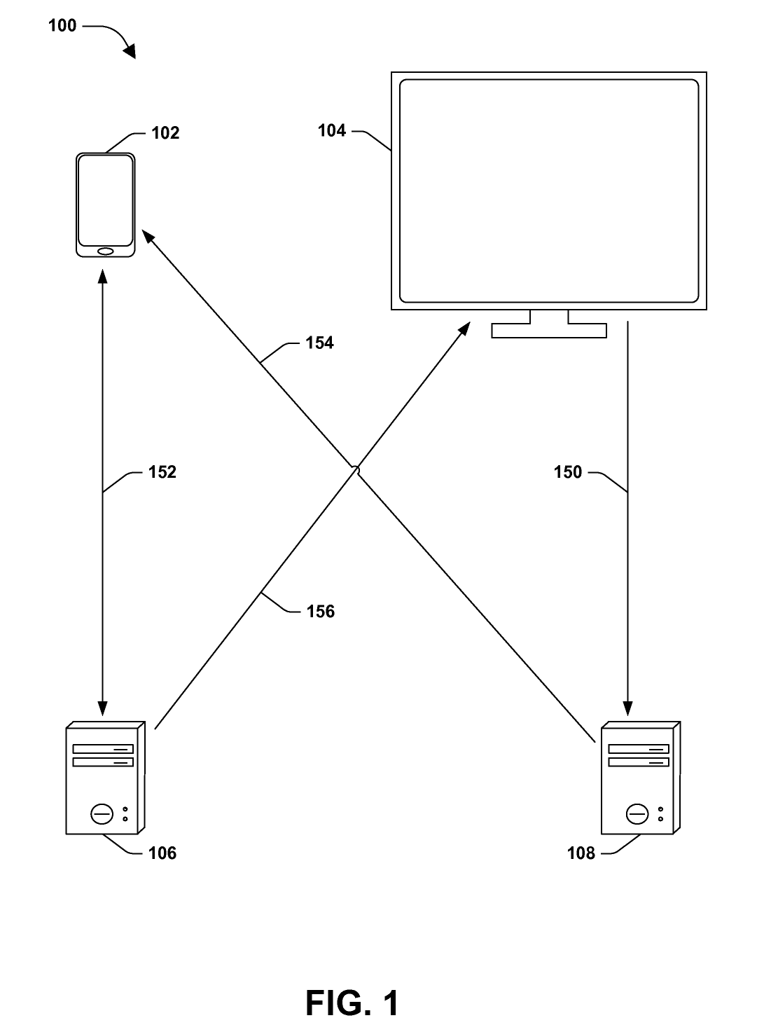

FIG. 1 is a diagram illustrating an example environment 100 where one or more techniques described herein may be implemented. A user's personal device 102, such as a smartphone, laptop, tablet device, etc., may be used to browse web-based content, such as using a browser resident on the personal device 102. As an example, the personal device 102 may use some form of wireless connection to the Internet (e.g., wifi, mobile phone connection, Bluetooth, etc.), and navigate to various sites on the Internet. The user may view 152 web-based content hosted by a remote content server 106 that they wish to view or display on a local device 104, such as a television or display screen in their home.

In this example environment 100, the local device 104 can be web-enabled, such that it can receive content from the Internet, for example, or some other network. For example, the local device may comprise a television or display device that is connected to a computing device (e.g., gaming console, computer, etc.) that connects to the Internet over a wired or wireless connection and/or may comprise a display device that is pre-configured to connect to the Internet, such as a television with an Internet connection component comprised therein, for example.

Further, the user may have pre-registered 150 their local device(s) with a remote device pairing service 108 (e.g., or the local device may automatically register upon powering up), such as comprised on a remote server connected to the Internet (or some other network). In this way, for example, the local device 104 may be discoverable for displaying web-based content identified by the personal device 102. For example, the user (or someone else) can use the web-enabled local device 104 to navigate to the remote device pairing service 108, where the local device 104 can be registered and associated with one or more or the user's personal devices (e.g., 102). Additionally, the user may register and associate a plurality of local devices (e.g., 104, such as TVs in their home, work or elsewhere) with a plurality of personal devices (e.g., 102, such as the user's handheld computer, smartphone, laptop, tablet device, PC, etc.).

In this example environment 100, when the user navigates 152 to the web-based content on the remote content server 106 (e.g., a website showing videos), for example, a webpage loaded 152 on the personal device 102 can comprise markup code that is loaded 154 from the remote device pairing service 108 (e.g., content in an iframe loaded from a universal resource identifier (URI) in the remote device pairing service 108). For example, the webpage from the remote content server 106 can be designed to comprise appropriate code that allows for markup code to be loaded 154 from the remote device pairing service 108.

In this way, for example, when the user interacts with the markup code loaded 154 from the remote device pairing service 108, information about and/or comprising, etc. the web-based content to be played on the local device 104 can be transferred 156 to the local device 104. In this example, a communication channel between the remote content server 106 and the local device 104 can be facilitated by the remote pairing service 108. The remote pairing service 108, for example, can identify a local device 104 (e.g., at the user's location) that is registered and associated with the user's personal device 102 used to find the web-based content. In this example, information identifying the local device 104 can be passed to the remote content server 106 to facilitate the sending and/or transfer, etc. 156 of the web-based content to the local device 104.

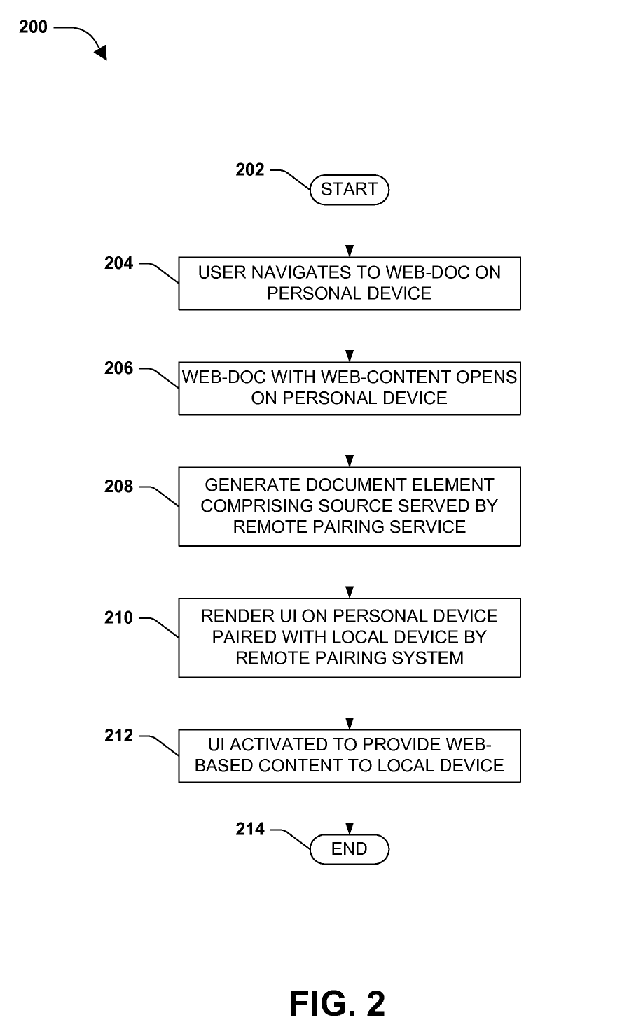

FIG. 2 is a flow diagram of an exemplary method 200 for sending web-based content to a local device using a personal device. The exemplary method 200 begins at 202 and involves a user navigating to a web-based document on a personal device of the user, at 204. For example, the user may use a browser on their smartphone to navigate to a webpage on a website, such as over the Internet. At 206, the web-based document, comprising web-based content opens on the user's personal device. For example, the web-based document can comprise a webpage comprising content, such as a video, image(s), text, audio file, or any other type of web-based content (e.g., multi-media content). In this example, when the web-based document opens on the user's personal device (e.g., smartphone) the web-based content can be identified in the document.

At 208, a document element is dynamically generated when the web-based document, comprising the web-based content, is opened on the personal device. Here, the document element comprises a source that is served by a remote pairing service. For example, web-pages can comprise document elements, such as textual elements, non-textual elements (e.g., images, audio, video elements), interactive elements (e.g., buttons, menus, interactive script, etc.), internal information, frames, and dynamically adapted information. In one embodiment, the dynamically generated document element can comprise a link to the remote paring service, for example, where a communication channel may be established between the user's personal device and the remote pairing service using the link in the dynamically generated document element.

At 210, a user interface (UI) is rendered on the personal device that provides the web-based content to the local device, when the UI is activated (e.g., clicked on). Here, the local device is paired with the personal device by the remote pairing service. For example, a user interactive element can be rendered on the webpage displayed on the user's personal device that provides for sending the web-based content to the local device (e.g., TV). In this example, the user may activate the interactive element, such as by selecting or clicking on it, which triggers the web-based content to be sent to the TV.

Further, for example, as described above, the document element comprises a source, such as a link from a URI served by the remote pairing service. In this way, in this example, the remote pairing service can help create the communication channel between the personal device (e.g., and web-based content thereon) and the local device, by providing locator information for the local device to a remote content provider of the web-based content. In this way, in this example, when the user activates the UI the web-based content can be sent to the local device over the communication channel that was facilitated by the remote pairing service.

At 212, the UI is activated, such as by a user gesture, and the web-based content selected by the user from their personal device is sent to the user's local device. In this way, for example, a user may browse the Internet and identify content that they wish to display on a larger screen, such as for others to view and/or to have a more desirable viewing experience. In this example, the user can simply click a button that says “send to TV,” and the desired web-based content will be displayed on a TV of the user's choosing.

Having provided the web-based content to the user's local device, the exemplary method 200 ends at 214.

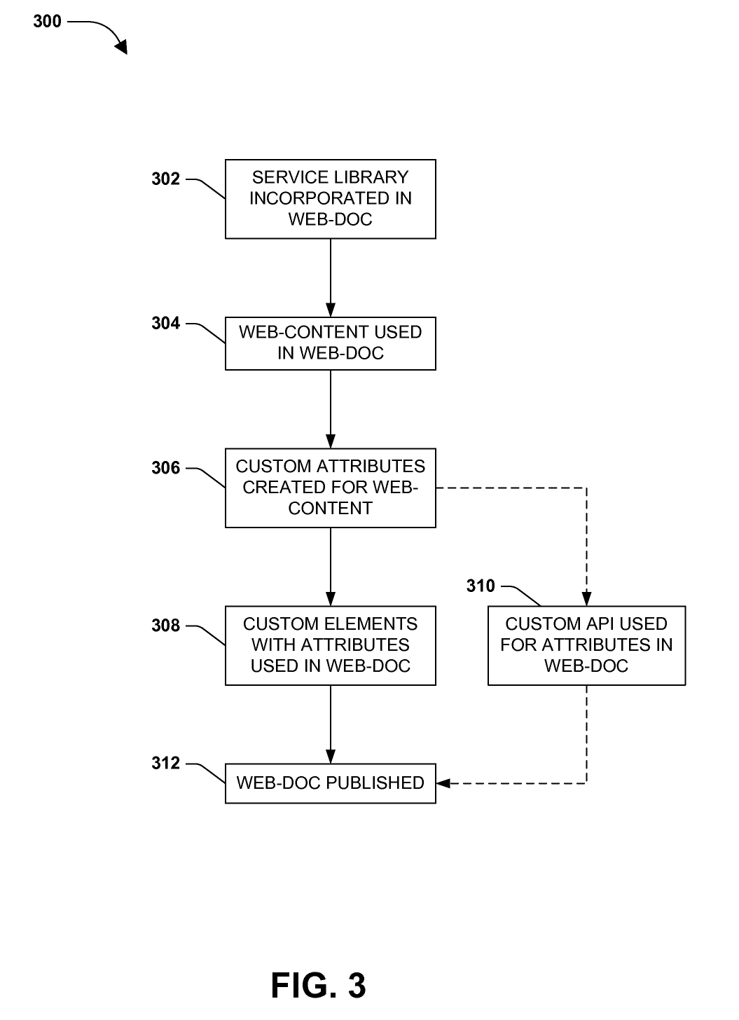

FIG. 3 is a flow diagram illustrating an example embodiment 300 where one or more portions of one or more techniques described herein may be implemented. At 302, a service library is incorporated into a web-based document. In one embodiment, the service library can comprise a scripting language library (e.g., a JavaScript, Jscript, or some other scripting code library for a webpage) from a remote pairing service. For example, a client side scripting language, such as JavaScript, can utilize a library comprising prewritten controls for the scripting language to be used in the webpage/web-based document.

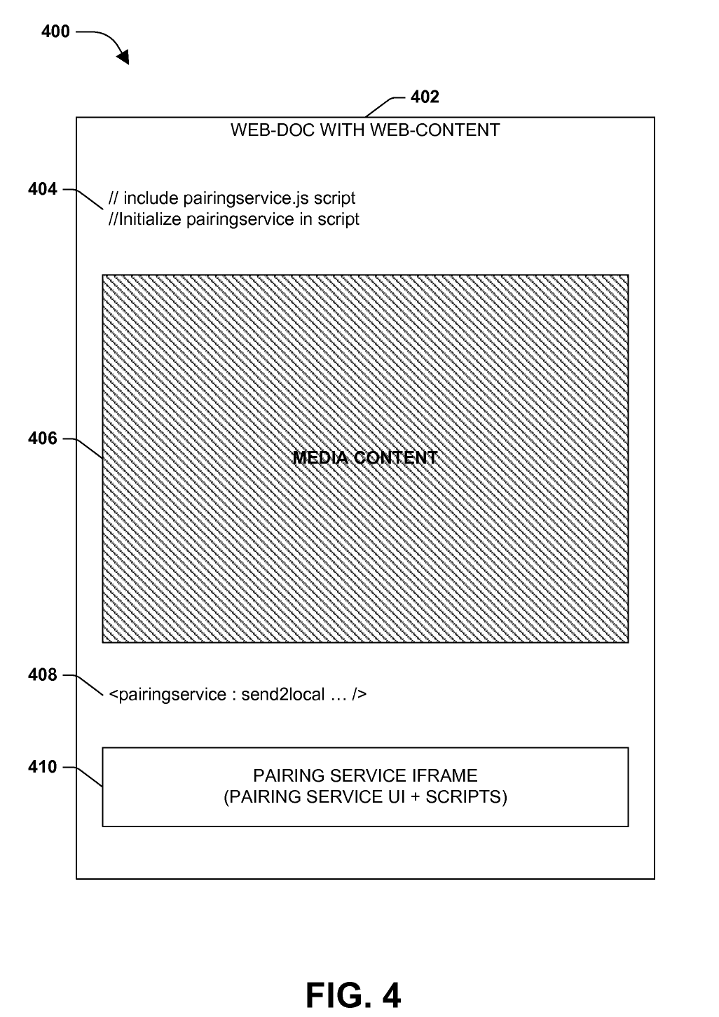

In one embodiment, the client side scripting language library provided for the web-based document can be associated with the remote pairing service, for example, such that the controls from the library may facilitate activation of document elements linked to the remote pairing service. As an illustrative example, FIG. 4 is an example embodiment 400 of a web-based document implementing one or more techniques described herein. In this example embodiment 400, the web-based document 402 comprises markup language 404 that incorporates the library “pairingservice.js,” and initializes the “pairingservice” library, which may be associated with the remote pairing service.

At 304, web-based content is used in development of the web-based document. For example, some desired content can be added to the web-page by the page developer, where the desired content may comprise, among other things, media, such as video (e.g., HTML5 video), audio, images, or some form of rich Internet applications streaming multimedia video, animation and graphics. In this example, the web-based content added to the webpage may comprise content that a user may wish to send to their local device, such as their living room TV. As an example, in FIG. 4, media content 406 is embedded in the web-based document 402, which may be played by the user on their personal device (e.g., laptop, handheld computer, etc.), such as using a standard browser, for example.

Custom attributes are created for the web-based content, at 306, such as by the webpage developer, and are used at 308. For example, because the webpage developer incorporated the scripting language library (e.g., pairingservice.js 404 from FIG. 4) into the webpage, the webpage developer can also add custom elements (e.g., HTML elements customized by the developer) to their webpage. As an example, as illustrated in FIG. 4, a custom element “pairingservice:send2local” 408 has been added to the web-based document 402 below the media content 406.

In one embodiment, the custom element can accept a set of parameters as element attributes, and these parameters can specify information about the web-based content to be sent to the local device. For example, the custom element may comprise an attribute that identifies the web-based content, such as a URI for the content (e.g., a location to retrieve the content, which may be different than that shown on the webpage due to different resolutions of the local device). Further, the custom element may comprise attributes that describe how the content is to be used/viewed. For example, there may be expiry attributes that limit an amount of time or views for the content; and/or the content owner may wish to provide limitations on viewing size, resolution, copying, and use of the content. In this embodiment, these attributes may be included in the custom element, such as by the webpage developer.

In an alternate embodiment, at 310 in the example embodiment 300, one or more application programming interfaces (APIs) may be used to customize attributes for the web-based content. For example, the scripting language library associated with the remote pairing service can comprise APIs that may be used by the web-based document (e.g., incorporated into the webpage by the developer) that can inject and/or specify parameters for the web-based content, and/or may indicate how information about the web-based content can be sent to the local device using the remote pairing service.

In these embodiments, for example, the webpage developer and/or content owner can have flexibility to control how the content is used on the local device. At 312, the web-based document, comprising the web-based content, can be published to the Internet. In this way, for example, the content is available to be viewed by a user and/or sent to a user's local device.

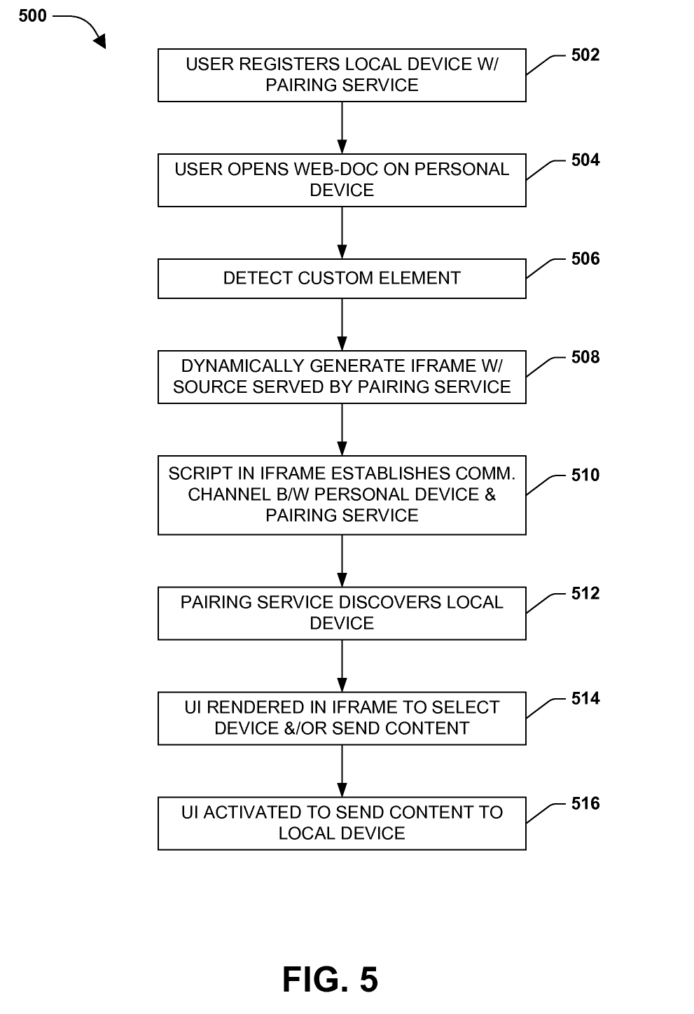

FIG. 5 is a flow diagram illustrating an example embodiment 500 where one or more portions of one or more techniques described herein may be implemented. At 502, a user registers their local device with a remote pairing service. As an example, the local device (e.g., web-enabled TV) may access the remote pairing service over a network (e.g., the Internet) to be registered as associated with one or more personal devices of the user. Further, as an example, the user may manually register the local device, such as by accessing the Internet and browsing to a website for the remote pairing service; and/or the local device may automatically (e.g., programmatically) register with the remote pairing service, such as by default when powered on.

At 504, the user opens the web-based document comprising the web-based content on their personal device (e.g., handheld computer). For example the user may utilize the device's browser to navigate to a content provider website that has incorporated remote pairing service scripting library. At 506, a custom element can be detected in the web-based document, where the custom element comprises one or more content attributes for the web-based content. In one embodiment, upon detecting the custom element, the document element can be generated using one or more controls in the remote pairing service scripting language library.

At 508, the document element comprises an iframe that is dynamically generated, comprising a source that is served by the remote pairing service. As an example, as illustrated in FIG. 4, an iframe 410 can be dynamically generated in the web-based document 402, where an iframe can comprise a link to a domain different than that of the webpage hosting the iframe, which may allow a service from that different domain to load content into the iframe 410.

In one embodiment, the iframe can comprise content that is loaded from a URI from the remote pairing service (e.g., a source served by the pairing service). For example, the content from the URI may comprise script that helps detect an association between the personal device and one or more local devices; and/or user interface (UI) content that can be used to send the web-based content to a desired local device.

At 510 in the example embodiment 500 of FIG. 5, script that is loaded to the iframe can establish a communication channel between the personal device and the remote pairing service. In one embodiment, establishing the communication channel can comprise using one or more request APIs that are associated with the document element, such as from the pairing service script library. In this way, for example, a communication channel may be established between the personal device and the remote pairing service, using the remote pairing service.

At 512, the remote pairing service is used to discover a desired local device for the personal device. For example, one or more local devices may be registered with the remote pairing service, and associated with one or more of the user's personal devices. In this example, the personal device that has identified the web-based content (e.g., used to navigate to the webpage comprising the content) can be identified by the remote pairing service, such as by a cross-domain communication channel between the iframe and the local browser, and matched with one or more registered local devices associated with the identified personal device.

In one embodiment, the remote pairing service may match the personal device to a plurality of local devices for the user. In this embodiment, for example, a selection UI may be provided to allow the user to select the desired local device to view the content. As another example, the remote pairing service may be able to identify a desired local device for the user, such as by detecting a nearest, a default, or preferred local device, etc. In this way, in this embodiment, the web-based content can be sent to the desired local device for the user.

At 514 in the example embodiment 500, a UI is rendered, such as in the iframe, where the UI may provide for selecting the desired local device, and/or provide for sending the web-based content to the desired local device. For example, the UI can comprise a list of potential local devices from which the user may select a desired device, such as in the iframe (e.g., 410 of FIG. 4). Further, the UI may comprise an element that can be activated by the user (e.g., by selecting or clicking on a “send2local” button) to initiate the sending of the web-based content to the selected local device. At 516, the UI is activated, such as by the user, to send the content to the local device, for example, where it may be used (e.g., viewed, manipulated, saved, etc.).

In one embodiment, the source in the document element (e.g., a link in the iframe to the remote pairing service) can be used to forward information about the web-based content to the remote pairing service. Further, in one embodiment, the remote pairing service can be used to forward the information about the web-based content to the local device. For example, the source in the document element may use a cross-domain communication channel between the iframe and the local browser to identify parameters from the document element, which can comprise a URI for the web-based content. In this example, the URI can be passed to the remote pairing service, which can then pass the URI to the local device.

In one embodiment, the local device can use the information about the web-based content (e.g., URI) that is forwarded to the local device to pull the web-based content from the web-based document (e.g., or some other location associated with the web-based document). In one embodiment, the web-based content can be rendered on a display that is associated with the local device upon activation of the UI on the personal device. That is, for example, the user of the personal device may merely utilize a simple gesture (e.g., select UI with finger on a touch screen of a handheld computer) to send the web-based content identified on the personal device to the user's local device where the content is then displayed thereon.

A system may be devised allows a user to view web-based content, found on the user's personal device, such as a smartphone or laptop, on a user's local device, such as a television in their home. The user may identify web-based content by browsing the Internet and identifying content desired for viewing on their local device, such as a video on a video sharing website, for example. The user can select the desired content using a simple gesture (e.g., selecting a button) to send the web-based content to a desired local device (e.g., a TV local to the user).

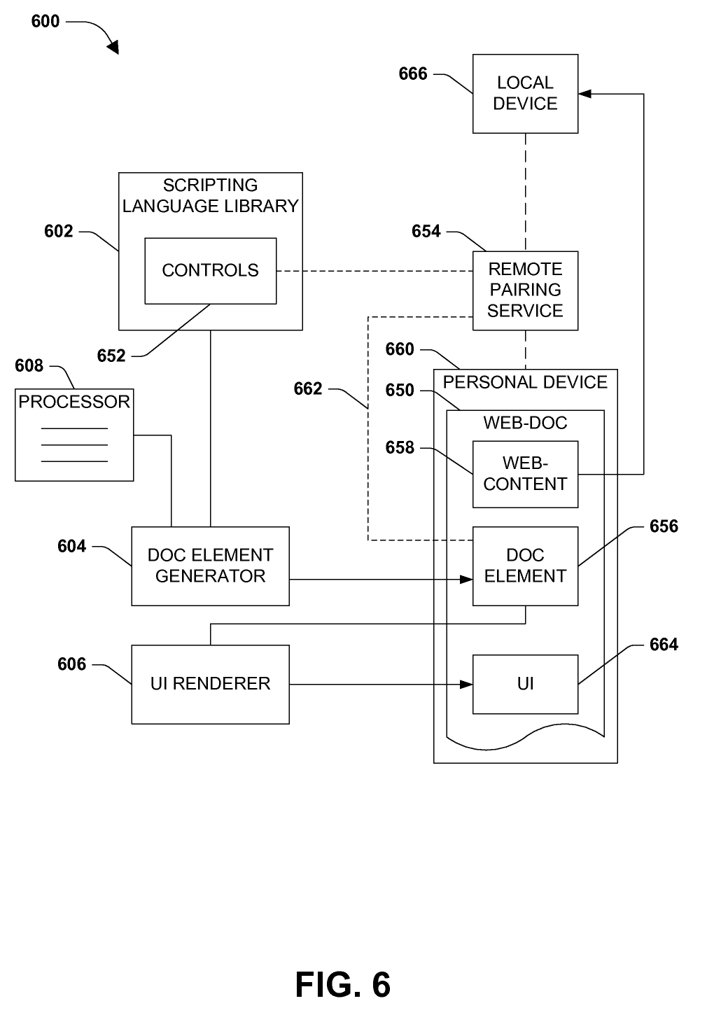

FIG. 6 is a component diagram of an exemplary system 600 for sending web-based content to a local device using a personal device. A computer-based processor 608 is configured to process data for the system. A scripting language library component 602 is incorporated in a web-based document 650, where the scripting language library component 602 comprises web-based document controls 652 that are associated with a remote pairing service 654. For example, the scripting language library component 602 can be incorporated into the web-based document 650 by the author/developer of the web-based document 650, such as by including appropriate markup language in the web-based document 650 that incorporates the scripting language library component 602.

A document element generation component 604 is operably coupled with both the computer-based processor 608 and the scripting language library component 602. The document element generation component 604 dynamically generates a document element 656 when the web-based document 650, comprising the web-based content 658, is opened on the personal device 660. Further, the dynamically generated document element 656 comprises a link 662 to the remote pairing service 654.

A user interface (UI) rendering component 606 is operably coupled with the dynamically generated document element 656, in the web-based document. The UI rendering component 606 renders a UI 664 on the personal device 660 that provides the web-based content 658 to the local device 666 when the UI is activated. Further, the local device 666 is paired with the personal device 660 by the remote pairing service 654. For example, a user can interact with the UI 664 generated by the UI rendering component 606, when it is displayed on the user's personal device, to send the web-based content to the user's local device.

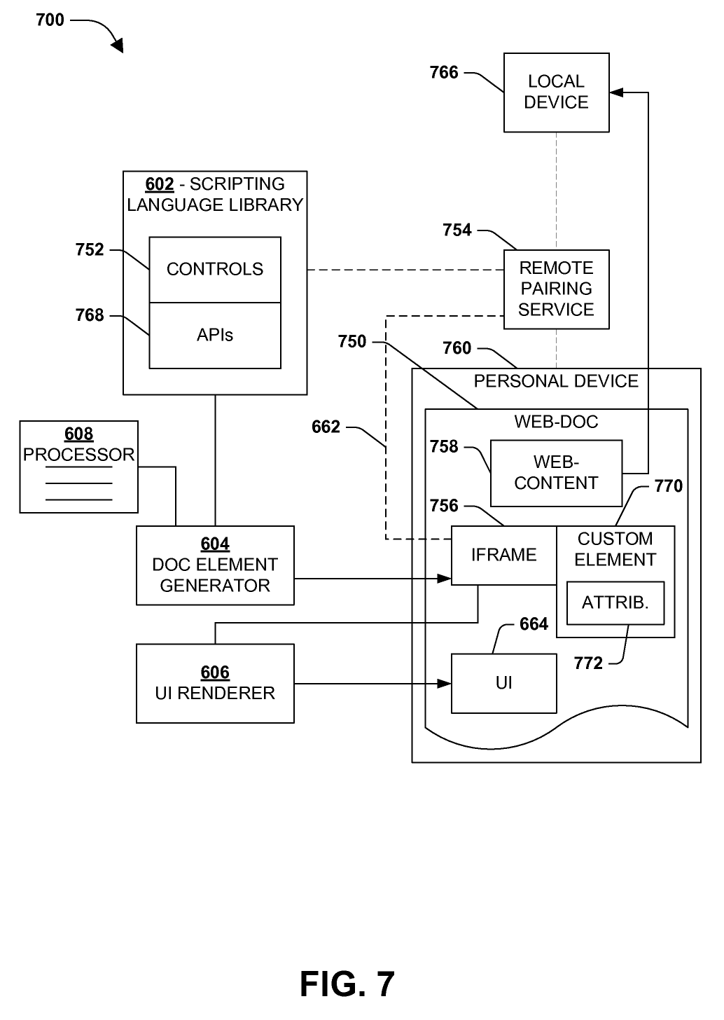

FIG. 7 is a component diagram illustrating one embodiment 700 where one or more systems described herein can be implemented. In this example, an extension of FIG. 6 is provided and thus description of elements, components, etc. described with respect to FIG. 6 may not be repeated for simplicity. In this embodiment 700, the dynamically generated document element comprises an inline frame element 756 that is dynamically generated by one or more controls 752 in the scripting language library component 602. Further, the inline frame element 756 can be dynamically generated upon detection of a custom element 770 in the web-based document 750. The custom element 770 in the web-based document 750 can comprise one or more attributes 772 for providing the web-based content 758 to the local device 766. For example, the custom element 770 may be incorporated into the web-based document 750 by the author/developer of the document 750, after incorporating the scripting language library component, for example.

In this embodiment 700, the remote pairing service 754 can be configured to register the local device 766 to receive web-based content (e.g., 758) for the personal device 760, such as identified by the user of the personal device 760. Further, the remote pairing service 754 can be configured to discover a desired local device (e.g., 766), from one or more local devices, where the desired local device can receive the web-based content 758 from the web-based document 750 that is identified by the personal device 760 (e.g., by the user).

Additionally, the remote pairing service 754 can provide information about one or more local devices, registered for the personal device, to the personal device. The remote pairing service 754 may retrieve information about the web-based content 758 from the personal device 760 over a communication channel that is established using the link from the dynamically generated inline frame element 756. The remote pairing service 754 can also provide the retrieved information about the web-based content 758 from the personal device 760 to the desired local device 766, which may be used to retrieve the web-based content 758 from the web-based document 750 (e.g., or another location that is associated with the web-based document 750, such as a URI identifying a location of the content).

In this embodiment 700, the scripting language library component can comprise script application programming interfaces (APIs) 768 that may specify attributes for the web-based content 758 to be provided to the local device 766. For example, an owner of the web-based content (e.g., a copyright holder) may want expiry limits associated with the content, and/or viewing/using limits for the content. In this example, these attributes may be injected/incorporated into the content 758 using the APIs 768 form the scripting language library component 602.

Further, one or more custom elements 770 may be utilized, where respective custom elements comprise one or more attributes 772 for the web-based content 758 that is to be provided to the local device 766. For example, instead of (e.g., or as well as) using the APIs 768 to apply attributes for the content 758, the custom elements can comprise the attributes 772 for the content 758. In one embodiment, the attributes 772 can comprise a URI that can identify the web-based content available to be provided to the local device. Further, the attributes 772 can comprise a use attribute that identifies how the web-based content 758 can be used by local device 766; a timing attribute that identifies a time for use of the web-based content 758; a security attribute that identifies which local devices may use the web-based content 758; and/or a display attribute that can identify how the web-based content 758 is displayed by the local device 766.

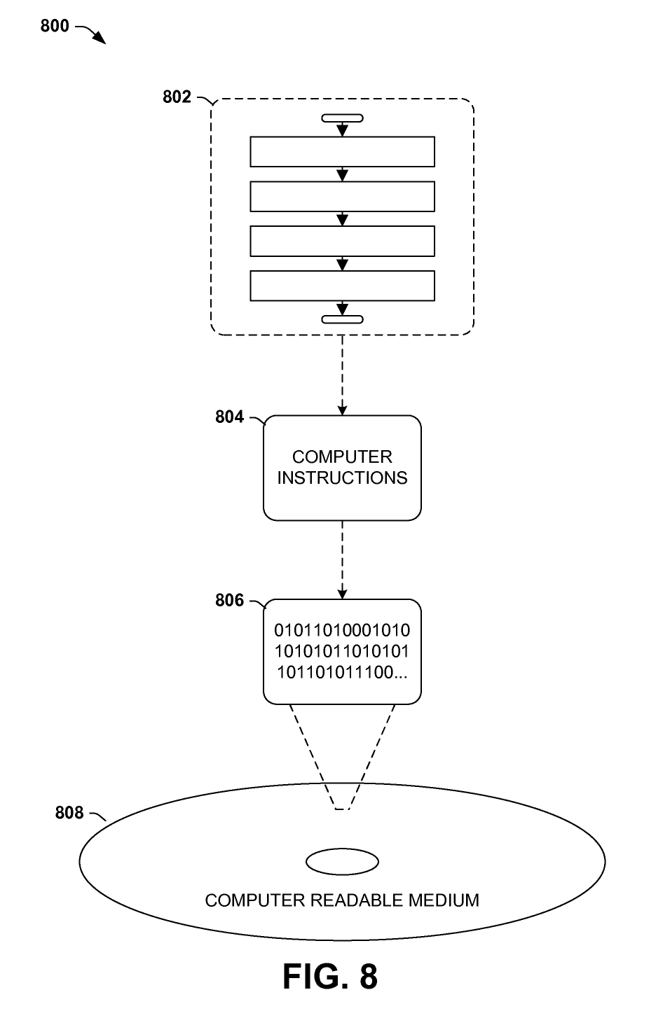

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 808 (e.g., a CD-R, DVD-R, or a platter of a hard disk drive), on which is encoded computer-readable data 806. This computer-readable data 806 in turn comprises a set of computer instructions 804 configured to operate according to one or more of the principles set forth herein. In one such embodiment 802, the processor-executable instructions 804 may be configured to perform a method, such as at least some of the exemplary method 200 of FIG. 2, for example. In another such embodiment, the processor-executable instructions 804 may be configured to implement a system, such as at least some of the exemplary system 600 of FIG. 6, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

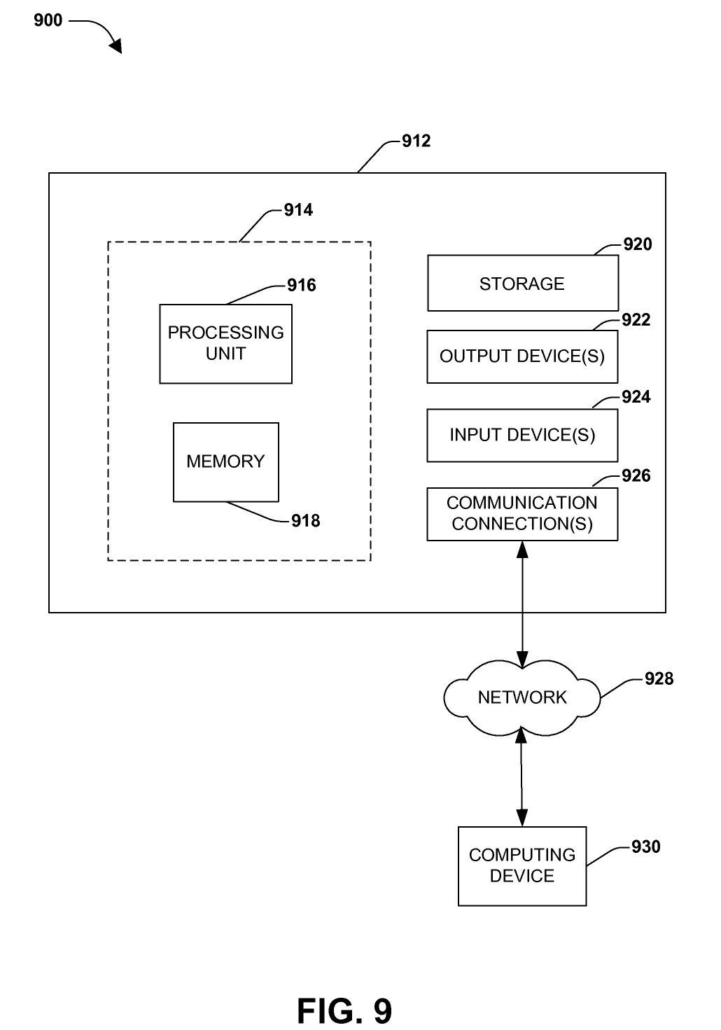

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for sending web-based content to a local device using a personal device, comprising:
dynamically generating a document element when a web-based document, comprising the web-based content, is opened on the personal device, where the document element comprises a source served by a remote pairing service; and
rendering a user interface (UI) on the personal device that, when activated, provides the web-based content to the local device, where the local device is paired with the personal device by the remote pairing service.

2. The method of claim 1, comprising registering the local device with the remote pairing service.

3. The method of claim 1, comprising incorporating a remote pairing service scripting language library in the web-based document.

4. The method of claim 3, comprising detecting a custom element in the web-based document, where the custom element facilitates providing the web-based content to the local device and comprises one or more content attributes for the web-based content.

5. The method of claim 3, generating the document element comprising using one or more controls in the remote pairing service scripting language library to generate the document element upon detection of a custom element comprising one or more content attributes for the web-based content.

6. The method of claim 1, comprising establishing a communication channel between the personal device and the remote pairing service using one or more request application programming interfaces (APIs) associated with the document element.

7. The method of claim 1, comprising using the remote pairing service to discover a desired local device for the personal device.

8. The method of claim 7, discovering the desired local device for the personal device comprising discovering a local device registered to the remote pairing service in association with the personal device.

9. The method of claim 1, rendering the UI comprising rendering a UI element that, when activated, selects a desired local device for the web-based content from a plurality of local devices.

10. The method of claim 1, comprising using the source in the document element to forward information about the web-based content to the remote pairing service.

11. The method of claim 10, comprising using the remote pairing service to forward the information about the web-based content to the local device.

12. The method of claim 10, using the information about the web-based content that is forwarded to the local device to pull the web-based content from the web-based document.

13. The method of claim 1, comprising rendering the web-based content on a display associated with the local device upon activation of the UI on the personal device.

14. A system for sending web-based content to a local device using a personal device, comprising:
a computer-based processor configured to process data for the system;
a scripting language library component configured to be incorporated in a web-based document and comprising web-based document controls associated with a remote pairing service;
a document element generation component operably coupled with the computer-based processor and the scripting language library component and configured to dynamically generate a document element when the web-based document, comprising the web-based content, is opened on the personal device, where the dynamically generated document element comprises a link to the remote pairing service; and
a user interface (UI) rendering component operably coupled with the dynamically generated document element and configured to render a UI on the personal device that, when activated, provides the web-based content to the local device, where the local device is paired with the personal device by the remote pairing service.

15. The system of claim 14, the dynamically generated document element comprising an inline frame element that is dynamically generated by one or more controls in the scripting language library component upon detection of a custom element in the web-based document.

16. The system of claim 15, the custom element in the web-based document comprising one or more attributes for providing the web-based content to the local device.

17. The system of claim 14, comprising the remote pairing service configured to perform one or more of:
register the local device to receive web-based content for the personal device;
discover a desired local device, from one or more local devices, for receiving the web-based content from the web-based document identified by the personal device;
provide information about one or more local devices registered for the personal device to the personal device;
retrieve information about the web-based content from the personal device over a communication channel established using the link from the dynamically generated document element; and
provide the retrieved information about the web-based content from the personal device to the desired local device for retrieving the web-based content from the web-based document.

18. The system of claim 14, the scripting language library component comprising script application programming interfaces (APIs) configured to specify attributes for the web-based content to be provided to the local device.

19. The system of claim 14, comprising one or more custom elements respectively comprising one or more attributes for the web-based content to be provided to the local device, the attributes comprising one or more of:
a uniform resource identifier (URI) configured to identify the web-based content available to be provided to the local device;
a use attribute configured to identify how the web-based content can be used by local device;
a timing attribute configured to identify a time for use of the web-based content;
a security attribute configured to identify which local devices may use the web-based content; and
a display attribute configured to identify how the web-based content is displayed by the local device.

20. A method for sending web-based content to a local device using a personal device, comprising:
incorporating a remote pairing service scripting language library in the web-based document comprising the web-based content;
dynamically generating a document element when a web-based document, comprising the web-based content, is opened on the personal device, where the document element comprises a source served by a remote pairing service, the generating of the document element comprising using one or more controls in the remote pairing service scripting language library to generate the document element upon detection of a custom element comprising one or more content attributes for the web-based content;
establishing a communication channel between the personal device and the remote pairing service using one or more request application programming interfaces (APIs) associated with the document element, where the communication channel is used to provide an identity of the local device;
rendering a user interface (UI) on the personal device that, when activated, provides the web-based content to the local device, where the local device is paired with the personal device by the remote pairing service; and
using the source in the document element to forward information about the web-based content to the remote pairing service, for use by the local device to pull the web-based content from the web-based document.
